(19) United States
(12) Patent Application Publication
(10) Pub. No.: US 2013/0018596 A1
(43) Pub. Date: Jan. 17, 2013

(54) METHOD AND DEVICE FOR DETERMINING TARGET BRAIN SEGMENTS IN HUMAN OR ANIMAL BRAINS

(71) Applicants: Joachim BÖTTGER, Berlin (DE); Alexander Abbushi, Berlin (DE); Daniel S. Margulies, Berlin (DE)

(72) Inventors: Joachim BÖTTGER, Berlin (DE); Alexander Abbushi, Berlin (DE); Daniel S. Margulies, Berlin (DE)

(73) Assignees: Max-Planck-Institut fur Kognitions- und Neurowissenschaften; Charite-Universitatsmedizin Berlin

(21) Appl. No.: 13/181,369

(22) Filed: Jul. 12, 2011

(51) Int. Cl. G06F 19/12

(52) U.S. Cl. 702/21; 702/19

(57) ABSTRACT

Method and device for determining target brain segments in human or animal brains

An embodiment of the invention relates to a method for determining at least one target brain segment of a human or animal brain for stimulation or manipulation of a specific brain function, said method comprising the steps of:
(a) receiving first data of a reference brain, said first data defining a reference network consisting of functionally correlated brain segments that perform said specific brain function,
(b) identifying the corresponding network in the human or animal brain,
(c) receiving second data of said reference brain, said second data comprising a description of at least one location in the reference network, said location defining a target brain segment for stimulation or manipulation of said specific brain function in the reference brain, and
(d) identifying at least one corresponding location in the corresponding network of the human or animal brain based on said description, said at least one corresponding location defining said at least one target brain segment of said human or animal brain.

The present invention relates to a method and device for determining target brain segments of a human or animal brain, e.g. for stimulation or manipulation of a specific brain function.

### BACKGROUND OF THE INVENTION

Functional connectivity analysis of resting-state fMRI data (fcrs-fMRI) of a human or animal brain has been shown to be a robust non-invasive method for localization of functional networks without using specific tasks, and to be promising for presurgical planning. Results of functional connectivity analysis of resting-state fMRI data are described in detail in the literature (Biswal B, Yetkin F Z, Haughton V M, Hyde J S (1995) “Functional connectivity in the motor cortex of resting human brain using echo-planar MRI”, Magn Reson Med 34:537-541; De Luca M, Beckmann C, De Stefano N, Matthews P, Smith S (2006) “fMRI resting state networks define distinct modes of long-distance interactions in the human brain”, NeuroImage 29:1359-1367; Di Martino A, Scheres A, Margulies D, Kelly A, Uddin L, Shehzad Z, Biswal B, Walters J, Castellanos F, Milham M (2008) “Functional Connectivity of Human Striatum: A Resting State fMRI Study”, Cereb. Cortex 18:2735-2747).

Many available data, such as the described resting-state fMRI data, have not yet been transferred to clinical everyday practice, nor made easily accessible to neurosurgeons. As such, visualization methods, visualization devices and stimulating or manipulating devices are needed that allow better access to the existing data.

### OBJECTIVE OF THE PRESENT INVENTION

An objective of the present invention is to provide a method for determining at least one target brain segment of a human or animal brain in order to aid a stimulation or manipulation of a specific brain function of the brain.

A further objective of the present invention is to provide a device for determining and/or visualizing at least one target brain segment of a human or animal brain in order to aid a stimulation or manipulation of a specific brain function of the brain.

A further objective of the present invention is to provide a stimulating or manipulating device allowing a stimulation or manipulation of a specific brain function of the brain.

### BRIEF SUMMARY OF THE INVENTION

An embodiment of the invention relates to a method for determining at least one target brain segment of a human or animal brain for stimulation or manipulation of a specific brain function, said method comprising the steps of:
(a) receiving first data of a reference brain, said first data defining a reference network consisting of functionally correlated brain segments that perform said specific brain function,
(b) identifying the corresponding network in the human or animal brain,
(c) receiving second data of said reference brain, said second data comprising a description of at least one location in the reference network, said location defining a target brain segment for stimulation or manipulation of said specific brain function in the reference brain, and
(d) identifying at least one corresponding location in the corresponding network of the human or animal brain based on said description, said at least one corresponding location defining said at least one target brain segment of said human or animal brain.

This embodiment allows determining target brain segments in human or animal brains even if those brains differ significantly from the reference brain (e.g. a “healthy” brain, or an average template generated from a multitude of “healthy” brains). If, for instance, brain segments of the human or animal brain are shifted or dysfunctional (e.g. in consequence of tumors inside the brain), a target brain segment, which is appropriate for the reference brain (“healthy” brain), may not be the best target brain segment for a human or animal brain which is different because of injury or disease. To address this problem, the proposed embodiment takes functional correlations into account and determines networks consisting of functionally correlated brain segments that perform the specific brain function. In this way, even brains with shifted or strongly modified brain sections may accurately be treated.

According to a preferred embodiment, said step (b) of identifying the corresponding network in the human or animal brain comprises the steps of:
measuring the brain activity of at least one section of said human or animal brain,
analyzing the measured brain activity data in order to identify a plurality of networks, each network consisting of a plurality of brain segments that show an identical or at least a similar brain activity,
out of said plurality of networks, selecting one network which is the most similar compared to the reference network of the reference brain, and
treating the most similar network as the corresponding network.

In order to determine the network that is the most similar compared to the reference network of the reference brain, the network's shape, the number of brain areas belonging to the network, and/or size may be taken into account.

A correlation value may be calculated for each network out of said plurality of identified networks, each correlation value describing the spatial correlation between the respective network and the reference network of the reference brain. Then, the network having the highest degree of correlation with respect to the reference network of said reference brain may be treated as the most similar network.

The spatial correlation may be determined using a first data set, which three-dimensionally defines the reference network, and a second data set, which three-dimensionally defines the plurality of networks as identified with respect to said human or animal brain.

The first data set and/or the second data set may be generated based on data provided by a functional magnetic resonance imaging, fMRI, device.

The brain segments are preferably treated as functionally correlated brain segments if their brain activity currently shows or has previously shown an identical or at least a similar brain activity.

Further, brain segments may be treated as functionally correlated brain segments if their metabolic activity over time currently shows or has previously shown an identical or at least a similar metabolic activity over time.

Preferably, brain segments are treated as functionally correlated brain segments if their oxygen and/or glucose consumption over time currently shows or has previously shown an identical or at least a similar oxygen and/or glucose consumption over time.

The at least one target brain segment and/or at least one of the functionally correlated brain segments may be visualized in real-time during change of the localization of an externally caused stimulation or manipulation effect.

A further embodiment of the invention relates to a control device capable of determining at least one target brain segment of a human or animal brain for stimulation or manipulation of a specific brain function, said device comprising:
a first unit capable of receiving first data of a reference brain, said first data defining a reference network consisting of functionally correlated brain segments that perform said specific brain function, wherein said first unit is further capable of identifying a corresponding network in the human or animal brain,
a second unit capable of receiving second data of said reference brain, said second data comprising a description of at least one location in the reference network, wherein said second unit is further capable of identifying the corresponding location in the corresponding network of the human or animal brain based on said description, said corresponding location defining said at least one target brain segment.

The control device may comprise a processor and a memory. In this case, the first and second units are preferably software modules stored in said memory and being run by said processor.

According to a preferred embodiment, the first unit is adapted to carry out the steps of:
analyzing measured brain activity data in order to identify a plurality of networks, each network consisting of a plurality of brain segments that show an identical or at least a similar brain activity,
out of said plurality of networks, selecting one network which is the most similar compared to the reference network of the reference brain, and
treating the most similar network as the corresponding network.

The first unit may further be adapted to carry out the steps of:
calculating a correlation value for each network out of said defined plurality of networks, each correlation value describing the spatial correlation between the respective network and the reference network of the reference brain, and
treating the network having the highest degree of correlation with respect to the reference network of said reference brain, as the most similar network compared to the reference network of the reference brain.

A further embodiment of the invention relates to a stimulating or manipulating device comprising a control device as described above, and a stimulation and/or manipulation unit capable of stimulating and/or manipulating at least one human or animal brain segment of a human or animal brain.

A further embodiment of the invention relates to a visualization device comprising a control device as described above, and a display unit capable of generating a superimposed image which shows the anatomy of the human or animal brain, a network to be stimulated or manipulated, and/or a target brain segment for stimulation or manipulation of the specific brain function.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures. Understanding that these figures depict only typical embodiments of the invention and are therefore not to be considered to be limiting of its scope, the invention will be described and explained with additional specificity and detail by the use of the accompanying drawings in which

FIG. 1 shows an exemplary embodiment of a control device according to the present invention,

FIG. 2 shows an exemplary embodiment of a visualization device according to the present invention,

FIG. 3 shows an exemplary embodiment of a stimulating or manipulating device according to the present invention,

FIG. 4 shows in exemplary fashion identified networks of a human or animal brain HAB which is meant to be stimulated or manipulated, and

FIG. 5 shows in exemplary fashion a reference network of a reference brain.

### DETAILED DESCRIPTION OF THE PREFERRED EMBODIMENTS

The preferred embodiments of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

The outcome of neurosurgical interventions benefits from knowledge about the location of specific functional areas in the brain. For example, pre-surgical identification of circumscribed functional regions in relation to a tumor can be a substantial advantage in surgical planning. The gold-standard method for such functional localization, intraoperative electrical stimulation mapping, is invasive and limited to the localization of a few main cortical functional areas accessible during intracranial interventions. In contrast, a non-invasive imaging technique, “task-based” functional magnetic resonance imaging (fMRI), is capable of non-invasively showing the location of a diverse array of functional regions by using task paradigms to identify the implicated areas (Vlieger E, Majoie C B, Leenstra S, den Heeten G J (2004) “Functional magnetic resonance imaging for neurosurgical planning in neurooncology”, European Radiology 14:1143-1153).

Although seemingly of great promise for clinical application, task-based fMRI has seen limited integration into the technical repertoire of neurosurgical planning due to several practical constraints: special experimental setup, relatively long measuring time, high demand on patients for cooperation, and the substantial training and expertise required for processing the data. Furthermore, localization of each functional area using task-based fMRI requires a specialized task.

A novel technique in functional neuroimaging termed “resting-state fMRI”, in contrast to traditional task-based fMRI, measures changes in BOLD (Blood-oxygen-level dependence) signal without the patient being subjected to any task (i.e. spontaneous fluctuations). A formidable body of research in brain and neurological science over the past years has demonstrated the feasibility of using spontaneous fluctuations in fMRI data to map functional systems.

Various functional areas and networks throughout the entire brain can be mapped using a single resting-state fMRI scan: The basic underlying observation is that even in a task-independent state, the brain shows spontaneous fluctuations in fMRI activity which are far from random. The correlation between spontaneous fluctuations across different regions reflects areas that are functionally relevant to each other, and can be described as “functionally connected” (Fox M D, Raichle M E (2007) Spontaneous fluctuations in brain activity observed with functional magnetic resonance imaging. Nat Rev Neurosci 8:700-711). The resulting methodology is termed “functional connectivity analysis of resting-state fMRI” (fcrs-fMRI). The classic method for the analysis of functional connectivity may be based on taking the signal from a region-of-interest (ROI) and assessing its correlation with all other regions of the brain (termed: “seed-based” functional connectivity).

Many other methods for the analysis of functional connectivity exist. For the exemplary embodiments described hereinafter, data-driven (“blind”) methods for the automatic separation of functional networks from resting state data may be employed. Such methods may include an Independent Component Analysis (ICA), which typically assumes the data is composed as a mixture of unknown, temporally uncorrelated signals, and decomposes the data into spatially independent components.

Exemplary embodiments of the invention as described hereinafter relate to a novel interactive tool allowing the exploration of task-based and/or resting-state fMRI data (and/or other data) for neurosurgical use.

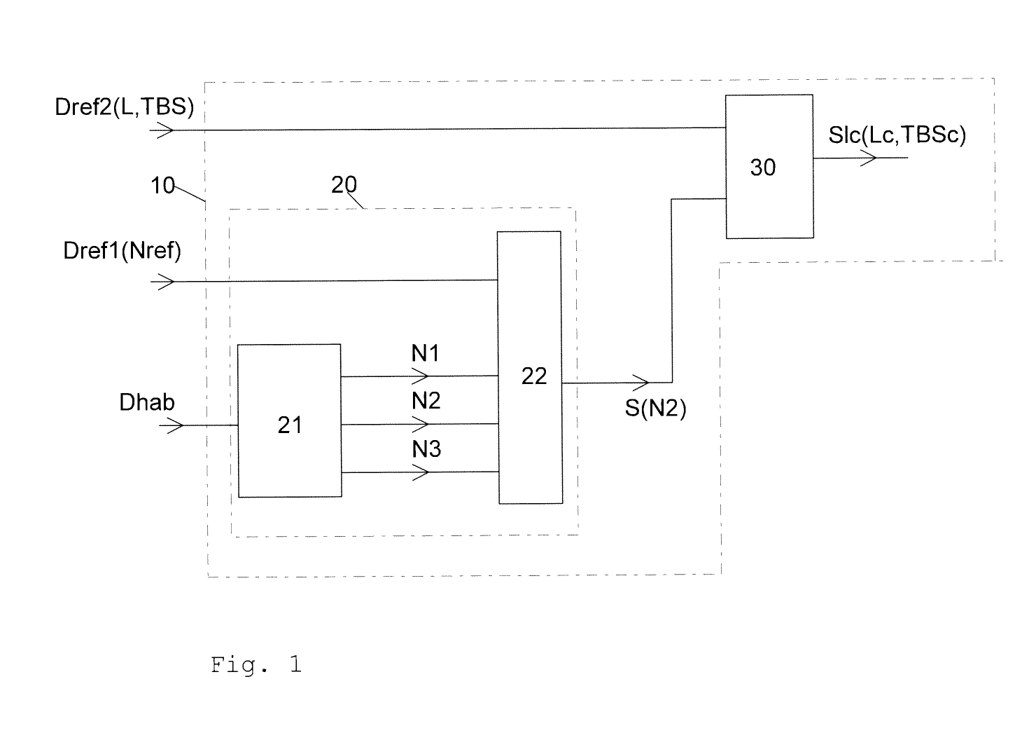

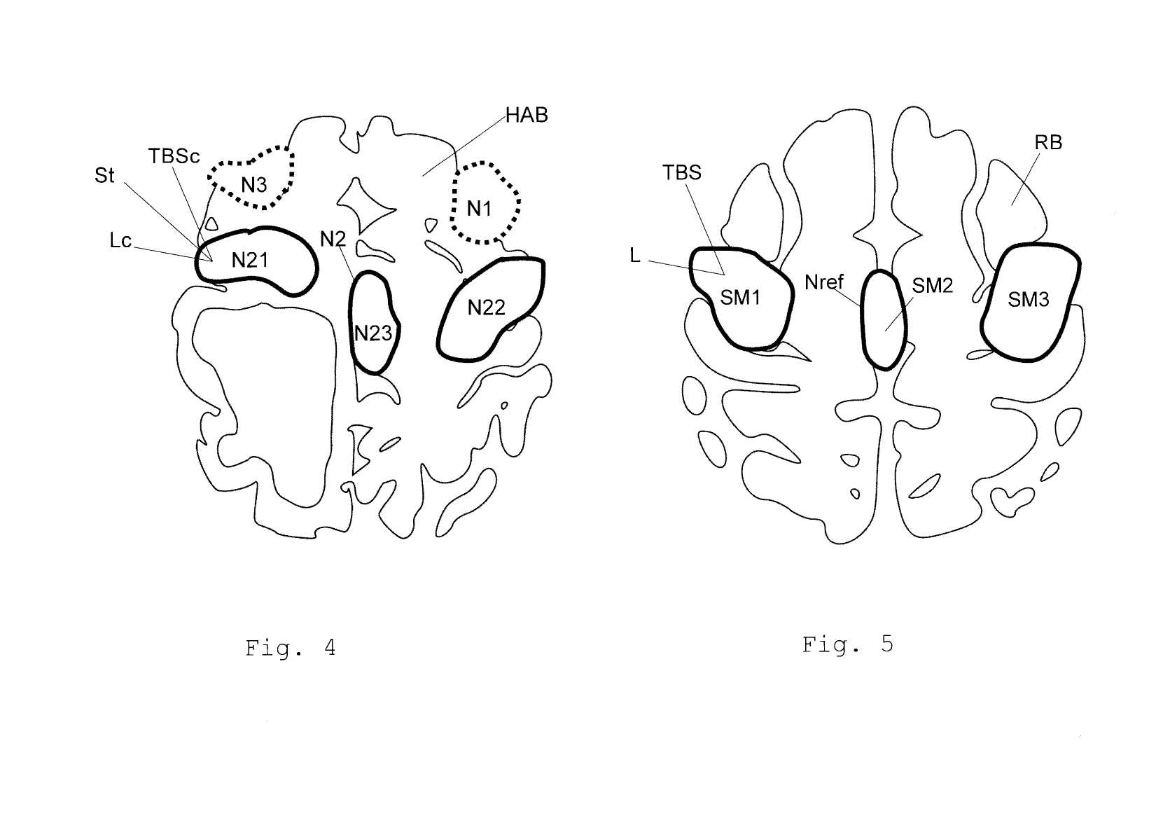

FIG. 1 shows an exemplary embodiment of a control device 10 which is capable of determining one or more target brain segments St of a human or animal brain HAB (see FIG. 4) for stimulation or manipulation of a specific brain function (e.g. motor system).

The control device 10 comprises a first unit 20 which receives a first three-dimensional brain activity data set (first data) Dref1 of a reference brain RB (see FIG. 5). The first data set Dref1 defines a reference network Nref (see FIG. 5) consisting of functionally correlated brain segments SM1, SM2, and SM3 that cooperate to perform the specific brain function. The first data set Dref1 may be based on or comprise resting-state functional MRI data provided by a functional magnetic resonance imaging, fMRI, device which is not shown in FIG. 1.

The first unit 20 further receives a second three-dimensional brain activity data set Dhab which has been measured with respect to the human or animal brain HAB. The second data set Dhab comprises metabolic activity data such as data describing oxygen and/or glucose consumption over time.

An analyzing module 21 of the first unit 20 analyzes the second data set Dhab in order to identify a plurality of networks N1, N2, and N3. FIG. 4 shows in an exemplary fashion that networks N1 and N3 may each consist of a single brain area whereas network N2 may consist of three brain areas N21, N22 and N23. The number of brain areas and their location inside the brain HAB is determined based on the second data set Dhab.

In order to identity the networks N1, N2, and N3, the analyzing module 21 assumes that the brain segments of the same network show an identical or at least a similar brain activity. In contrast, brain segments showing different brain activities are assumed to belong to different networks. As such, by filtering those brain segments which show similar brain activities, the networks N1, N2, and N3 may be found by numerical evaluation. The networks N1, N2, and N3 of the human or animal brain HAB, which are identified by the analyzing module 21, are shown in FIG. 4.

In order to enhance the identification step, the number of networks which the analyzing module 21 is supposed to identify, may be limited. For instance, the analyzing module 21 may be configured to identify three networks as shown in FIG. 4, or more networks (e.g. twelve networks).

It is assumed hereinafter that each of said plurality of networks N1, N2, and N3 performs a particular brain function (e.g. motor system, speech, etc.) in the human or animal brain HAB. However, at the evaluation stage carried out by the analyzing module 21, it is not yet determined, which particular function each identified network N1, N2, and N3 might perform. The identification of the network performing the specific brain function which is supposed to be stimulated or manipulated, is made by a correlation module 22 as will be discussed hereinafter in further detail.

The correlation module 22 of the first unit 20 compares the spatial correlation between each network N1, N2, and N3 and the reference network Nref of the reference brain RB, and selects the network which is the most similar compared to the reference network Nref of the reference brain RB (see FIG. 5). To this end, the correlation unit 22 may take the network's shape, the number of brain areas belonging to the network, and/or size into account.

For instance, the correlation unit 22 may calculate a correlation value for each network N1, N2, and N3, wherein each correlation value describes the spatial correlation between the respective network and the reference network Nref of the reference brain RB. The network having the highest degree of correlation with respect to the reference network of the reference brain forms the most similar network. This network will be treated as the network that “corresponds” to the network of the reference brain RB.

In the exemplary embodiments shown in FIGS. 4 and 5, network N2 as shown in FIG. 4 is obviously the most similar compared to the reference network Nref of the reference brain RB. It can be seen that both networks Nref and N2 consist of three brain areas having comparable size and shape.

After determining the most similar network N2, the first unit 20 generates a signal S(N2) that identifies network N2 as the “corresponding” network in the human or animal brain. Preferably, the signal S(N2) also comprises a spatial (three-dimensional) description of the “corresponding” network N2.

The control device 10 further comprises a second unit 30 which receives the signal S(N2) from the first unit 20, and third data Dref2. The third data Dref2 comprise a description of at least one location L which defines a target brain segment TBS for an efficient stimulation or manipulation of the specific brain function with respect to the reference brain RB. The target brain segment TBS is indicated in FIG. 5.

The second unit 30 applies the description of the location L to the “corresponding” network N2 and identifies a corresponding location Lc in the corresponding network N2 of the human or animal brain HAB (see FIG. 4). This corresponding location Lc thus defines a corresponding target brain segment TBSc which allows an efficient stimulation or manipulation of the specific brain function with respect to the human or animal brain HAB.

The description of the location L in the reference brain RB may relate to any spatial information related to the reference network Nref. For instance, the location L may be defined as the geometrical center of the reference network Nref or any location shifted with respect to the geometrical center along a given vector.

The second unit 30 generates and outputs a signal Slc that defines the location Lc and/or the respective target brain segment TBSc for an efficient stimulation or manipulation of the specific brain function with respect to the human or animal brain HAB. The signal Slc may be used to visualize the location Lc and/or the respective target brain segment TBSc, and/or to control an external stimulating or manipulating device to stimulate or manipulate the target brain segment TBSc.

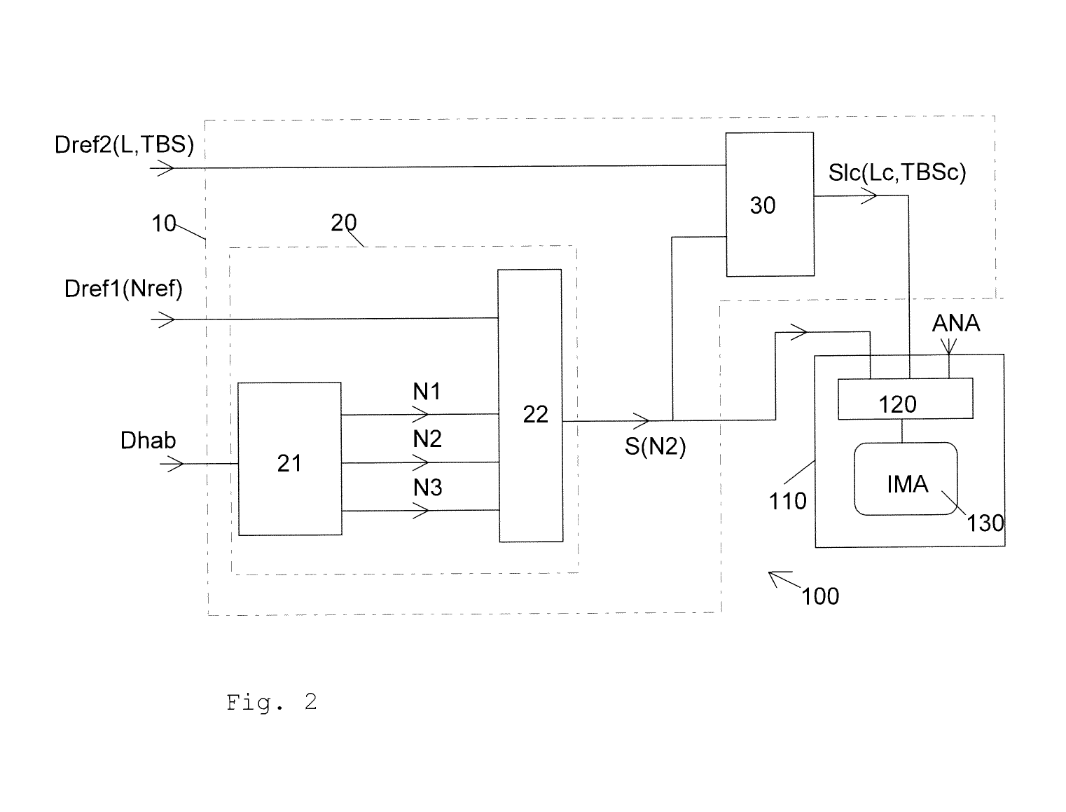

FIG. 2 shows an exemplary embodiment of a visualization device 100 comprising a control device 10 as described with respect to FIG. 1. The visualization device 100 further comprises a display unit 110.

The display unit 110 comprises a superimposing unit 120 which allows entering anatomy data ANA which describe the anatomy of the human or animal brain HAB. The anatomy data ANA may comprise or consist of tomograms generated by MRI tomography. The superimposing unit 120 further allows entering the signal Slc that defines the location Lc and/or the respective target brain segment TBSc. The superimposing unit 120 further allows entering the signal S(N2) that contains a spatial description of the “corresponding” network N2 in the human or animal brain HAB.

The superimposing unit 120 may provide a superimposed image IMA which shows the anatomy of the human or animal brain HAB, the “corresponding” network N2, and/or the target brain segment TBS for stimulation or manipulation of the specific brain function. The superimposed image IMA may be shown on a screen 130 of the display unit 110.

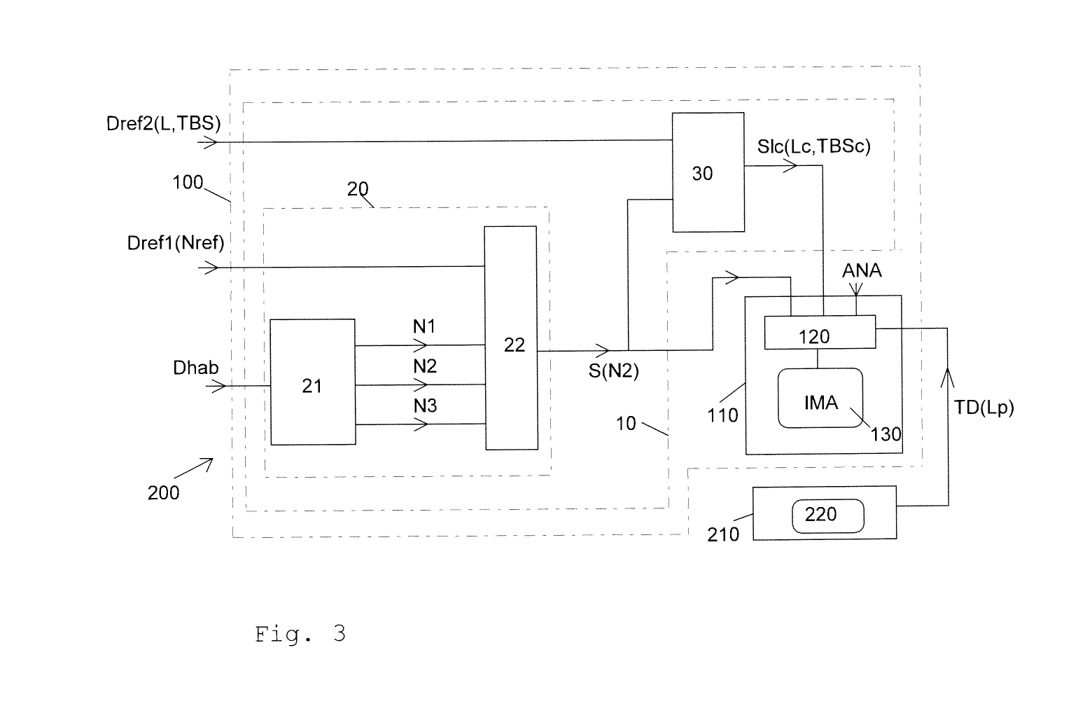

FIG. 3 shows an exemplary embodiment of a stimulating or manipulating device 200. The stimulating or manipulating device 200 comprises a visualization device 100 as described with reference to FIG. 2 and a stimulation and/or manipulation unit 210 capable of stimulating and/or manipulating at least one human or animal brain segment of the human or animal brain HAB.

The display unit 110 of the visualization device 100 is connected to the stimulating or manipulating unit 210 and receives target data TD that define the predicted location Lp where the stimulation or manipulation effect induced by the stimulation and/or manipulation unit 210 will probably occur.

The display unit 110 may provide a superimposed image IMA which shows the anatomy of the human or animal brain HAB, the “corresponding” network N2, the target brain segment TBS for stimulation or manipulation of the specific brain function, and/or the predicted location Lp of the stimulation or manipulation effect.

For stimulation and/or manipulation, the stimulation or manipulation unit 210 preferably generates a focused electrical or magnetic field inside the brain. To this end, the stimulation or manipulation unit 210 may comprise at least one magnetic coil, which may be placed outside the brain, to generate a magnetic field inside the brain. Additionally or alternatively, the stimulation or manipulation unit 210 may comprise at least one electrode, which may be placed inside or outside the brain, to generate an electric field inside the brain.

The stimulation or manipulation unit 210 may further comprise a control unit 220 which allows a user to change the location of the stimulation or manipulation effect. The control unit preferably generates the target data TD defining three dimensional coordinates of the location where the stimulation and/or manipulation effect is currently concentrated.

For providing the images as described above with reference to FIGS. 1-5, MR scanner systems may be used. The following parameters may be established to optimize the measurements results: On a GE 3-Tesla scanner equipped with an 8-channel head coil, fMRI may be acquired using a standard echo-planar imaging sequence (repetition time=2500 ms, echo time=30, flip angle=83°, voxel dimensions=1.71873×1.71873×4 mm). High resolution “anatomical” images may be obtained using a T1-weighted pulse sequence (MPRAGE, TR=7224 s; TE=3.1 ms; TI=900 ms; flip angle=8; 154 slices, FOV=240 mm). On a Siemens 3-Tesla Tim Trio scanner equipped with a 12-channel head coil, fMRI may be acquired using a standard echo-planar imaging sequence (repetition time=2300 ms, echo time=30, flip angle=90°, voxel dimensions=3×3×4 mm). Anatomical scans may be obtained using a T1 weighted pulse sequence (MPRAGE, TR=1900/2300 ms; TE=2.52/2.98 ms; TI=900 ms; flip angle=9; 192/176 slices, FOV=256 mm).

The data may be preprocessed using a combination of Freesurfer (http://surfer.nmr.mgh.harvard.edu/), AFNI (http://afni.nimh.nih.gov/), and FSL (http://www.fmrib.ox.ac.uk/fsl/), all freely available standard data analysis packages. Preprocessing for the functional data, which has been described previously may include: slicetiming correction for interleaved slice acquisition and motion correction in six degrees-of-freedom (AFNI). The six motion components and a “global” signal (extracted from the average signal over the entire brain) may be used as covariates in a general linear model. The residual data may then be bandpass filtered between 0.02-0.08 Hz and spatially smoothed using a 6 mm full-width half-maximum Gaussian kernel (AFNI).

Typically, the functional measurements consist of isotropic samplings on a voxel grid with 3-4 mm voxel size, using a standard BOLD-sensitive EPI sequence for rapid volumetric coverage of the whole brain (typ. 17×14×10 cm field of view). The measurements are sensitive to changes in blood oxygenation, and typically a complete volume is acquired every 1-4 seconds. Recent advances have made resolutions in the submillimeter range and much shorter acquisition times with multiple volumes per second possible. Further improvements can be expected. It is also possible to increase spatial and temporal resolution by restricting the sampling to a sub-region of the brain. Therefore, achievable resolution ranges from a few millimeters down to 0.1 mm and even lower, depending on sampling and other parameters. Other modalities like Positron Emission Tomography (PET), Magnetoencephalography (MEG), and Electroencephalography (EEG) may result in similar functional datasets of localized changes in brain function over time.

The anatomical volume may be skull stripped using the standard Freesurfer processing path. A single functional volume may then be registered to the skull-stripped anatomical volume using FSL's linear registration tool, and the resulting transformation matrix may be applied to the entire functional data set. The resulting data for can then be registered to a “healthy”, or a average template of healthy brains. The latter can be fabricated by co-registration of a multitude of “healthy” anatomical scans, matching functional data, and averaging of the different functional networks.

Examples for functional networks are the “sensorimotor” network, a usually symmetrical network across pre- and post-central gyri, as well as supplementary motor area, the “language” network, consisting of Broca's area and Wernicke's area, the “dorsal-attention” network, which usually has components bilaterally in the superior frontal gyrus as well as the intraparietal sulcus, and the “default-mode” network with regions in the posterior cingulate, medial prefrontal cortex, as well as bilateral inferior parietal cortex.

### REFERENCE SIGNS

10 control device
20 first unit
21 analyzing module
22 correlation module
30 second unit
100 visualization device
110 display unit
120 superimposing unit
130 screen
200 stimulating or manipulating device
210 stimulation and/or manipulation unit
220 control unit
ANA anatomy data
Dhab a second data set
Dref1 first data set
Dref2 third data
HAB human or animal brain
IMA superimposed image
L location
Lc corresponding location
Lp predicted location
Nref reference network
N1,N2,N3 networks
N21,N22,N23 brain areas
RB reference brain
SM1,SM2,SM3 functionally correlated brain segments
St target brain segment
S(N2) signal
TBS target brain segment
TBSc corresponding target brain segment
Slc signal
TD target data

1. A method for determining at least one target brain segment of a human or animal brain for stimulation or manipulation of a specific brain function, said method comprising the steps of:
(a) receiving first data of a reference brain, said first data defining a reference network consisting of functionally correlated brain segments that perform said specific brain function,
(b) identifying the corresponding network in the human or animal brain,
(c) receiving second data of said reference brain, said second data comprising a description of at least one location in the reference network, said location defining a target brain segment for stimulation or manipulation of said specific brain function in the reference brain, and
(d) identifying at least one corresponding location in the corresponding network of the human or animal brain based on said description, said at least one corresponding location defining said at least one target brain segment of said human or animal brain.

2. Method of claim 1, wherein said step (b) of identifying the corresponding network in the human or animal brain comprises the steps of:
measuring the brain activity of at least one section of said human or animal brain,
analyzing the measured brain activity data in order to identify a plurality of networks, each network consisting of a plurality of brain segments that show an identical or at least a similar brain activity,
out of said plurality of networks, selecting one network which is the most similar compared to the reference network of the reference brain, and
treating the most similar network as the corresponding network.

3. Method of claim 2, wherein the network's shape, the number of brain areas belonging to the network, and/or size is taken into account in order to determine the network that is the most similar compared to the reference network of the reference brain.

4. Method of claim 2,
wherein a correlation value is calculated for each network out of said plurality of identified networks, each correlation value describing the spatial correlation between the respective network and the reference network of the reference brain, and
wherein the network having the highest degree of correlation with respect to the reference network of said reference brain is treated as the most similar network.

5. The method of claim 4 wherein the spatial correlation is determined using a first data set, which three-dimensionally defines the reference network, and a second data set, which three-dimensionally defines the plurality of networks as identified with respect to said human or animal brain.

6. The method according to claim 5 wherein said first data set and/or the second data set is generated based on data provided by a functional magnetic resonance imaging, fMRI, device.

7. Method of claim 1 wherein brain segments are treated as functionally correlated brain segments if their brain activity currently shows or has previously shown an identical or at least a similar brain activity.

8. Method of claim 1 wherein brain segments are treated as functionally correlated brain segments if their metabolic activity over time currently shows or has previously shown an identical or at least a similar metabolic activity over time.

9. Method of claim 8 wherein brain segments are treated as functionally correlated brain segments if their oxygen and/or glucose consumption over time currently shows or has previously shown an identical or at least a similar oxygen and/or glucose consumption over time.

10. The method according to claim 1 wherein the at least one target brain segment and/or at least one of the functionally correlated brain segments is visualized in real-time during change of the localization of an externally caused stimulation or manipulation effect.

11. A control device capable of determining at least one target brain segment of a human or animal brain for stimulation or manipulation of a specific brain function, said device comprising:
a first unit capable of receiving first data of a reference brain, said first data defining a reference network consisting of functionally correlated brain segments that perform said specific brain function, wherein said first unit is further capable of identifying a corresponding network in the human or animal brain,
a second unit capable of receiving second data of said reference brain, said second data comprising a description of at least one location in the reference network, wherein said second unit is further capable of identifying the corresponding location in the corresponding network of the human or animal brain based on said description, said corresponding location defining said at least one target brain segment.

12. The control device according to claim 11 comprising a processor and a memory.

13. The control device according to claim 12 wherein said first and second units are software modules stored in said memory and being run by said processor.

14. The control device according to claim 11 wherein said first unit is adapted to carry out the steps of:
analyzing measured brain activity data in order to identify a plurality of networks, each network consisting of a plurality of brain segments that show an identical or at least a similar brain activity,
out of said plurality of networks, selecting one network which is the most similar compared to the reference network of the reference brain, and
treating the most similar network as the corresponding network.

15. The control device according to claim 14 wherein said first unit is adapted to carry out the steps of:
calculating a correlation value for each network out of said defined plurality of networks, each correlation value describing the spatial correlation between the respective network and the reference network of the reference brain, and
treating the network having the highest degree of correlation with respect to the reference network of said reference brain, as the most similar network compared to the reference network of the reference brain.

16. A stimulating or manipulating device comprising a control device according to claim 1, and a stimulation and/or manipulation unit capable of stimulating and/or manipulating at least one human or animal brain segment of a human or animal brain.

17. Visualization device comprising a control device according to claim 1, and a display unit capable of generating a superimposed image which shows the anatomy of the human or animal brain, a network to be stimulated or manipulated, and/or a target brain segment for stimulation or manipulation of the specific brain function.
